(19) United States
(12) Patent Application Publication
(10) Pub. No.: US 2007/0280497 A1
(43) Pub. Date: Dec. 6, 2007

(54) Communications Unit With Arrangement For Loud Reproduction Of Sound

(76) Inventors: Peter Isberg, Lund (SE); Magnus Hansson, Lund (SE)

Correspondence Address: MYERS BIGEL SIBLEY & SAJOVEC, P.A., P.O. BOX 37428, RALEIGH, NC, 27627, US

(21) Appl. No.: 10/592,998

(22) PCT Filed: Mar. 10, 2005
(86) PCT No.: PCT/EP05/02601

§ 371 Date: May 7, 2007

Related U.S. Application Data
(60) Provisional application No. 60/559,160, filed on Apr. 2, 2004.

(30) Foreign Application Priority Data
Apr. 1, 2004 (EP) 04388027.7

(51) Int. Cl. H04R 1/22; H04R 1/28

(52) U.S. Cl. 381/345

(57) ABSTRACT

A clamshell phone with two movable housing parts and can assume a closed position, in which the sound openings are covered, and an open position, in which the sound openings are exposed. According to the invention the two housing parts, when in the closed position, define, together with the speaker transducer, a closed cavity with a tube connecting the cavity to the ambient air. This arrangement makes it possible for a communications unit to use the speaker transducer both for reproducing the speech from the teleconversation partner with high quality, and for generating a loud alerting signal and also for reproducing the speech from the teleconversation partner with a sound level that is high enough to be perceived by one or more listeners at a distance from the unit. The invention is useful in mobile phones, cordless and wired telephone handsets.

### FIELD OF THE INVENTION

This invention relates to communications units such as mobile phones, cordless phones and telephone handsets for being held against an ear of a user during a telephone conversation, and which have the capability of also creating sound levels high enough to be audible even when the unit is at a considerable distance such as a few metres from the user's ear.

### BACKGROUND OF THE INVENTION

When the communications unit is distant from the user's ear, e.g. in stand-by mode, the unit will emit a ringing sound signal to alert the user of an incoming call. Some communications units have the possibility of also operating in a “speakerphone” mode, in which speech signals from the teleconversation partner are reproduced loud enough to be perceived by one or more users at a distance from the unit.

Normally, the earpiece speaker transducer will not be able to generate a sound level that is high enough to be perceived at a distance of more than a few cm's from the unit. When designing loudspeaker ports for alert and speaker phone functions etc, it will often be necessary to trade sound quality to sound level. If it is desired to optimise for maximum loudness at some frequency or a frequency band, this can be obtained by using resonators in front of the speaker diaphragm. The resonators can be of Helmholtz or quarter-wave type or a combination thereof. This makes it possible to hear the alerting sound even when the phone is placed e.g. in a bag or a pocket of a jacket.

However, such arrangements also produce an unpleasant sound that is far from being high quality sound reproduction. A flat high frequency response normally requires a large porting area with no resonance in the audio frequency band.

The object of the invention is to provide a communications unit that can operate in the traditional “handheld” mode, where the user holds the unit against one of his ears, and also in the speakerphone mode, where same the speaker transducer is used for reproducing speech signals in both handheld mode and in speakerphone mode and also for giving alerting signals.

U.S. Pat. No. 6,104,808 discloses a mobile telephone of the “clamshell” type with two hinged housing parts that can be folded to overlay each other in a “closed” position and folded apart to an “open” position. In the closed position a cavity in the first housing part is brought into communication, through overlaying sound ports in the two parts, with the front side of the speaker transducer in the second housing part, and sound exits through openings in the opposite side of the second housing part.

### SUMMARY OF THE INVENTION

The invention provides a communications unit with a first housing part with a speaker transducer arranged in the first housing part to output sound signals through one or more sound openings in a housing wall of the first housing part, and a second housing part movably connected to the first housing part so that the first and second housing parts can be moved to assume a closed position, in which the second housing part covers the one or more sound openings, and moved apart to assume an open position, in which the one or more sound openings are exposed. According to the invention the first and second housing parts, when in the closed position, define, together with the speaker transducer, a closed cavity with a tube connecting the cavity to the ambient air.

This arrangement makes it possible for a communications unit to use the speaker transducer both for reproducing the speech from the teleconversation partner with high quality and for generating a loud alerting signal (ringing) and also for reproducing the speech from the teleconversation partner with a sound level that is high enough to be perceived by one or more listeners at a distance from the unit.

In a first embodiment the housing parts are connected via a hinge like a book or a “clamshell” so that the housing parts can be folded between the open position and the closed position. In a second embodiment the housing parts can slide relative to each other to assume the open position and the closed position. The sliding movement can be a linear movement or a rotating movement.

In one preferred embodiment the resonator is a Helmholtz resonator with a cavity having an opening to the ambient air, where the resonance frequency is determined by the volume of air in the cavity in combination with the acoustic mass of the air in the opening.

In another preferred embodiment the cavity is capable of supporting standing waves in the resonator, e.g. at an integer multiple of a quarter of the wavelength at the resonance frequency.

The invention is useful in mobile phones, in cordless and wired telephone handsets.

### BRIEF DESCRIPTION OF THE DRAWINGS

FIG. 1 shows a preferred embodiment of a communications unit according to the invention in an open position seen from the front,

FIG. 2 shows the communications unit in FIG. 1 seen from the side,

FIG. 3 shows the communications unit in FIG. 2 in a closed position,

FIG. 4 shows the details marked IV in FIG. 2,

FIG. 5 shows the details marked V in FIG. 3,

FIG. 6 shows the details of another preferred embodiment corresponding to FIG. 4, and

FIG. 7 shows the details of the embodiment in FIG. 6 corresponding to FIG. 5.

### DETAILED DESCRIPTION OF THE INVENTION

The figures illustrate the underlying principles of the invention and are not drawn to scale.

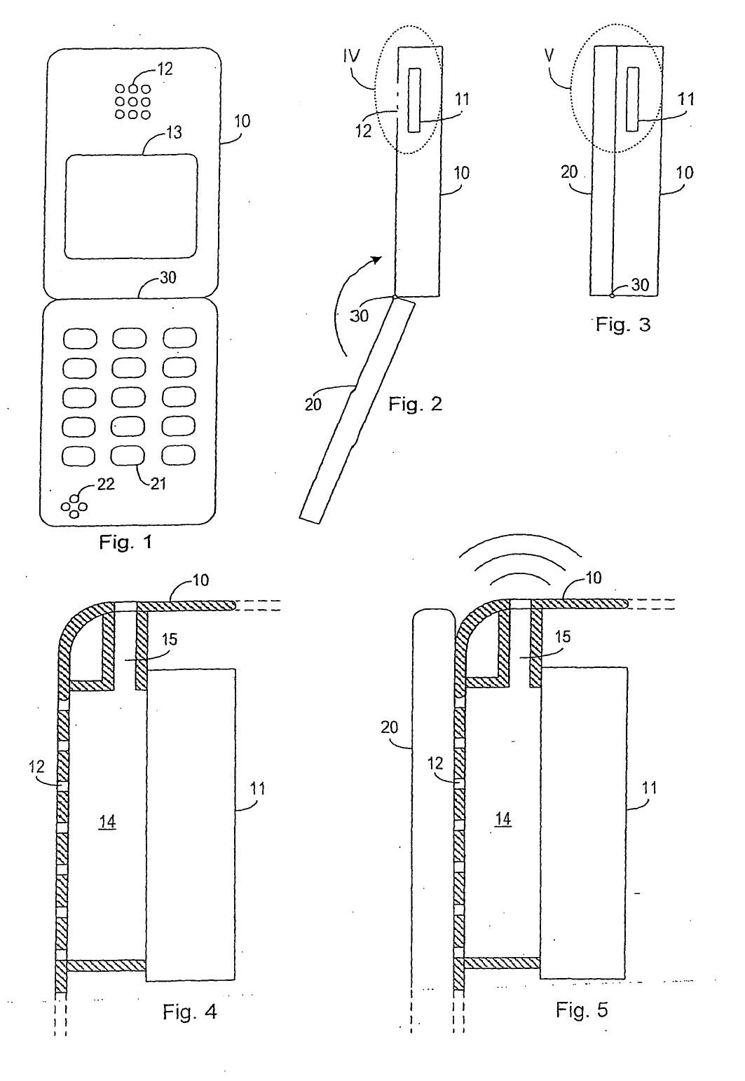

In FIGS. 1 to 3 is illustrated a mobile phone of the “clamshell” type, i.e. where the housing has a first housing part 10 and a second housing part 20 that are interconnected by a hinge 30. The first and second housing parts 10 and 20 can be moved about the hinge 30 to assume an open position as in FIGS. 1 and 2 and a closed position as in FIG. 3. As illustrated, the first and second housing parts can be of equal size (except for their thickness), or they can be of different size.

A speaker transducer 11 is accommodated within the first housing part 10. Further electronic components and circuit for the operation of the mobile phone is accommodated in either or both of the housing parts and may include a display 13, a keyboard 21 and a microphone that communicates through sound openings 22 in the housing wall.

In FIG. 4 is shown the details marked IV in FIG. 2. The speaker transducer 11 is mounted within the first housing part 10 at a distance from the housing wall, so that a cavity 14 is defined between the speaker transducer 11 and the housing wall. The speaker transducer 11 communicates with the ambient air through sound openings 12 in the housing wall. This is the open position, where the sound openings 12 are exposed, and the user can hold the phone against his ear for normal handheld use. A tube 15 connects the cavity 14 to the ambient air. With the sound openings 12 exposed as in FIG. 4 the acoustic impedance of the tube 15 is higher than the acoustic impedance of the sound openings 12, and the acoustic load of the tube 15 on the speaker transducer can therefore be neglected.

In FIG. 5 is shown the details marked V in FIG. 3, where the mobile phone is in its closed position. The second housing part 20 overlays the first housing part 10 and covers the sound openings 12, and the speaker transducer 11 now only communicates with the ambient air through the cavity 14 and the tube 15.

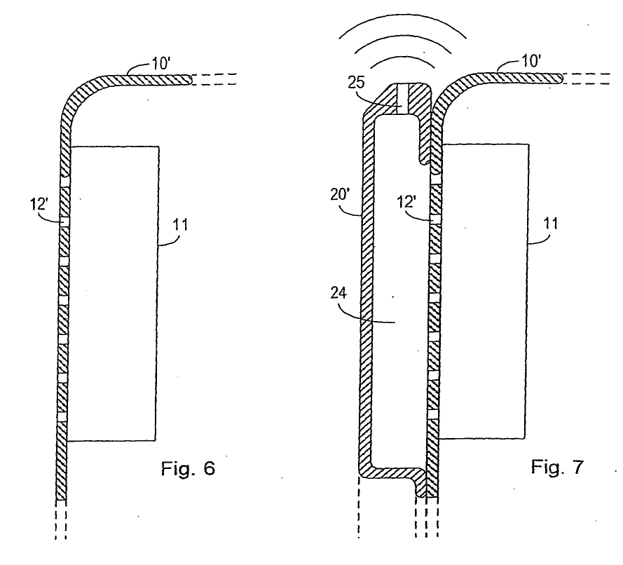

FIGS. 6 and 7 show another preferred embodiment of the invention. The speaker transducer 11 is accommodated within the first housing part 10′, but here the speaker transducer is mounted against the inner side of the housing wall. A user can hold the mobile phone with the exposed sound openings 12′ against his ear for normal handheld use.

FIG. 7 shows the mobile phone in its closed position with the second housing part 20′ overlaying and covering the sound openings 12′. The second housing part 20′ has a cavity 24 and a tube 25 connecting the cavity 24 to the ambient air. The transducer 11 now communicates with the ambient air through the cavity 24 and the tube 25.

The cavities 14, 24 and the corresponding tubes 15, 25 form Helmholtz resonators with a resonance frequency determined by the volume of air in the cavities 14, 24 and the acoustic mass of the air in the tubes 15, 25. By proper dimensioning of the cavities 14, 24 and the corresponding tubes 15, 25 it is thus possible to tune the resonance frequency of the Helmholtz resonators to a frequency of the alerting signal or to a frequency band comprising such frequency, which will be amplified by the Helmholtz resonators.

The bandwidth of the Helmholtz resonators is determined by the damping of the resonators. A highly damped resonator has a larger bandwidth than a less damped resonator. The damping depends mainly on the dimensions of the tubes 15, 25. For use in speakerphone mode a larger bandwidth is desirable, and the resonance therefore needs to be correspondingly damped.

In both embodiments the tubes 15, 25 are shown as through-going openings in the housing wall. The tubes 15, 25 may also be formed by grooves in the outer sides of either or both of the first and second housing parts, which upon closing the first and second housing parts form the tubes. This makes the manufacture of the housing parts simpler. Naturally, the two shown embodiments can be combined, so that the second housing part 20′ in FIG. 7 can be used with the embodiment in FIGS. 4 and 5, whereby the resulting cavity is the combination of the cavity 14 in the first housing part and the cavity 24 in the second housing part.

If the transducer is used not only for ringing and/or in speakerphone mode, but also for receiver in handheld mode (held against the ear), the tube from the cavity to the ambient air lowers the acoustical output impedance of the receiver system. The tube acts as an acoustical load in parallel with the receiver system output impedance. This makes the phone more tolerant to possible leaks between the outer side of the housing wall and the user's ear, whereby the effect of variations in the contact with the users' ears is reduced. Further, it also enhances the acoustic safety. In case the phone is by mistake held against the ear when a ringer sound (or other loud sound) is played, the sound pressure will be lower than it would have been without the arrangement of the invention.

1. A communications unit comprising:
a first housing part with a speaker transducer arranged in the first housing part to output sound signals through one or more sound openings in a housing wall of the first housing part, and
a second housing part movably connected to the first housing part so that the first and second housing parts can be moved to assume a closed position, in which the second housing part covers the one or more sound openings, and moved apart to assume an open position, in which the one or more sound openings are exposed, wherein
the first and second housing parts, when in the closed position, together with the speaker transducer define a closed cavity with an opening connecting the cavity to the ambient air, where the cavity and the opening form a resonator with a resonance frequency and a resonance bandwidth.

2. A communications unit according to claim 1, wherein the cavity defines a space between the housing wall and the transducer.

3. A communications unit according to claim 1, wherein the cavity defines a space between the housing wall and the second housing part.

4. A communications unit according to claim 1, wherein connecting the cavity to the ambient air extends through a tube in one of the first and second housing parts.

5. A communications unit according to claim 1, wherein a groove in one of the first and second housing parts forms the opening connecting the cavity to the ambient air, when the first and second housing parts are in the closed position.

6. A communications unit according to claim 1, wherein the resonator comprises a Helmholtz resonator.

7. A communications unit according to claim 1, wherein the cavity is configured to form standing waves in the resonator at an integer multiple of a quarter of the wavelength at the resonance frequency.

8. A communications until according to claim 2, wherein the cavity defines a space between the housing wall and the second housing part.

9. A communications until according to claim 2, wherein the opening connecting the cavity to the ambient air extends through a tube in one of the first and second housing parts.

10. A communications until according to claim 3, wherein the opening connecting the cavity to the ambient air extends through a tube in one of the first and second housing parts.

11. A communications unit according to claim 2, wherein a groove in one of the first and second housing parts forms the opening connecting the cavity to the ambient air, when the first and second housing parts are in the closed position.

12. A communications unit according to claim 3, wherein a groove in one of the first and second housing parts forms the opening connecting the cavity to the ambient air, when the first and second housing parts are in the closed position.

13. A communications unit according to claim 4, wherein a groove in one of the first and second housing parts forms the opening connecting the cavity to the ambient air, when the first and second housing parts are in the closed position.

14. A communications unit according to claim 2, wherein the cavity is configured to form standing waves in the resonator at an integer multiple of a quarter of the wavelength at the resonance frequency.

15. A communications unit according to claim 3, wherein the cavity is configured to form standing waves in the resonator at an integer multiple of a quarter of the wavelength at the resonance frequency.

16. A communications unit according to claim 4, wherein the cavity is configured to form standing waves in the resonator at an integer multiple of a quarter of the wavelength at the resonance frequency.
